(19) United States
(12) Patent Application Publication
(10) Pub. No.: US 2008/0225821 A1
(43) Pub. Date: Sep. 18, 2008

(54) CHANNEL ACCESS ARBITRATION MECHANISM FOR WALKIE-TALKIE DEVICES

(76) Inventor: Michael FAITH, Coram, NY (US)

Correspondence Address: FAY KAPLUN & MARCIN, LLP, 150 BROADWAY, SUITE 702, NEW YORK, NY, 10038, US

(21) Appl. No.: 11/685,270

(22) Filed: Mar. 13, 2007

(51) Int. Cl. H04J 1/00

(52) U.S. Cl. 370/343

(57) ABSTRACT

A mobile device with walkie-talkie functionality initiates a half-duplex transmission, which prompts a transmission request to be sent to a server mediating audio transmissions within channels of the network. The server receives the transmission request and determines if the requested channel is currently busy. An access grant or refusal message is sent to the mobile device accordingly. The access grant message may accord rights to a channel to the mobile device until the audio transmission has been sent, at which point a transmission completion message may be sent to the server. The access refusal message may also detail a list of alternately available channels and/or automatically tune the mobile device to one of said alternately available channels.

### FIELD OF THE INVENTION

The present invention relates to a channel access arbitration mechanism for walkie-talkie devices.

### BACKGROUND

Walkie-talkie devices use a half-duplex multicast system where one user may transmit an audio transmission across a certain channel to any plurality of recipients. This half-duplex transmission is transmitted over a Voice over Internet Protocol (VOIP) network, where voice conversations are routed to their destination over the internet via any series of routers and servers. In the half-duplex transmission, only one user may transmit an audio signal across a channel at any given time. Any plurality of recipients that are tuned into this channel may receive the audio transmission. Therefore, under one scenario, if two users were to initiate an audio transmission at essentially the same time, only the signal which is transmitted first will be multicast, while the second user will have its session ignored.

Under another scenario, some recipients will respond to the first user who transmits, while others may respond to the second transmitter if those other recipients receive, due to network effects, the transmission of the second user before that of the first user.

Additionally, two users on different networks may attempt to multicast a signal at the same time. In this case, each network separately identifies who initiated their transmission first. It is therefore possible to have the undesirable situation where multiple audio transmissions are sent across one channel at the same time.

### SUMMARY OF THE INVENTION

Accordingly, in the exemplary embodiments of the present invention, a mobile device with walkie-talkie functionality (e.g., a cell phone, a personal digital assistant, a walkie-talkie, a two-way radio, a data acquisition device, etc.) is provided with a channel access arbitration mechanism to streamline the process of multicasting audio transmissions.

A server system may be employed to mediate audio transmissions within channels of a network. The server system may receive transmission requests from mobile devices wishing to transmit audio signals across a channel. The server may then determine if the requested channel is currently in use and send an access grant or refusal message to the mobile device accordingly. The access grant and refusal messages may allow or deny rights to the requested channel, respectively. Additionally, the refusal message may incorporate a list of alternately available channels for the mobile device to use. The refusal message may also automatically tune the mobile device to an alternately available channel.

### BRIEF DESCRIPTION OF THE DRAWINGS

The accompanying drawings, which are incorporated in and constitute a part of this specification, illustrate several embodiments of the invention and, together with the description, serve to explain the principles of the invention. In the drawings:

FIG. 1 shows a first exemplary system for employment of a channel access arbitration mechanism according to an exemplary embodiment of the present invention.

FIG. 2 shows a first exemplary method for the first system of FIG. 1.

FIG. 3 shows a second exemplary system for employment of a channel access arbitration mechanism according to an exemplary embodiment of the present invention.

FIG. 4 shows a second exemplary method for the second system of FIG. 3.

### DETAILED DESCRIPTION

A method and system are herein described for providing a channel access arbitration mechanism for wireless mobile devices with half-duplex walkie-talkie capabilities (e.g., a cell phone, a personal digital assistant, a walkie-talkie, a two-way radio, a data acquisition device, etc.). The aforementioned arbitration system seeks to prevent a condition where multiple mobile devices simultaneously transmit an audio transmission over a particular channel at the same time. Additionally, the present invention allows mobile devices the option to be able to communicate over a walkie-talkie channel without having to wait for a particular channel to become available.

Walkie-talkie devices such as those noted above may operate as Voice over Internet Protocol (VOIP) devices such that the routing of the audio transmissions from sender to recipient(s) is done via the use of one or more servers within the network. The present invention seeks to take advantage of these servers to be able to create a central arbitration system for the regulation of audio transmissions sent across any particular channel.

The present invention may be further understood with reference to the following description and the appended drawings. An exemplary embodiment of the present invention describes a system including a plurality of mobile devices involved in a half-duplex communication transmission over a particular channel

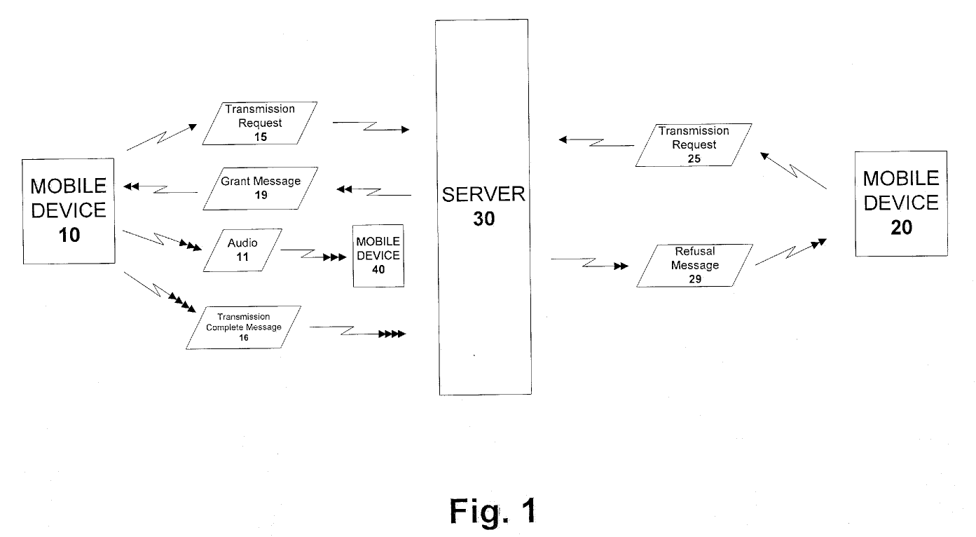

FIG. 1 shows a first system according to an exemplary embodiment of the present invention. Initially, the mobile device 10 and the mobile device 20 are both prepared to transmit audio signals over the same channel. Those skilled in the art will understand that the selection of the channel may be done via any conventional means. The user of the mobile device 10 is first to engage the “Push to Talk” button and therefore, the first to send a transmission request 15 to a server 30.

When the server 30 receives the transmission request 15, it checks to see if there is any current activity on the channel in question. In this case, the channel to be used is free and, as such, the server sends a grant message 19 to the mobile device 10. The grant message 19 accords mobile device 10 the rights to the channel in question. Accordingly, as long as the mobile device 10 continues to press the “Push to Talk” button, an audio signal 11 may be transmitted across the channel to a recipient, mobile device 40, who is tuned to the channel in question. Those skilled in the art will understand that the audio signal 11 may be transmitted to any plurality of recipients that are tuned to the channel in question. Once the mobile device 10 releases the “Push to Talk” button, a transmission complete message 16 is sent to the server 30. The transmission complete message 16 notifies the server 30 that the channel is once again available for use.

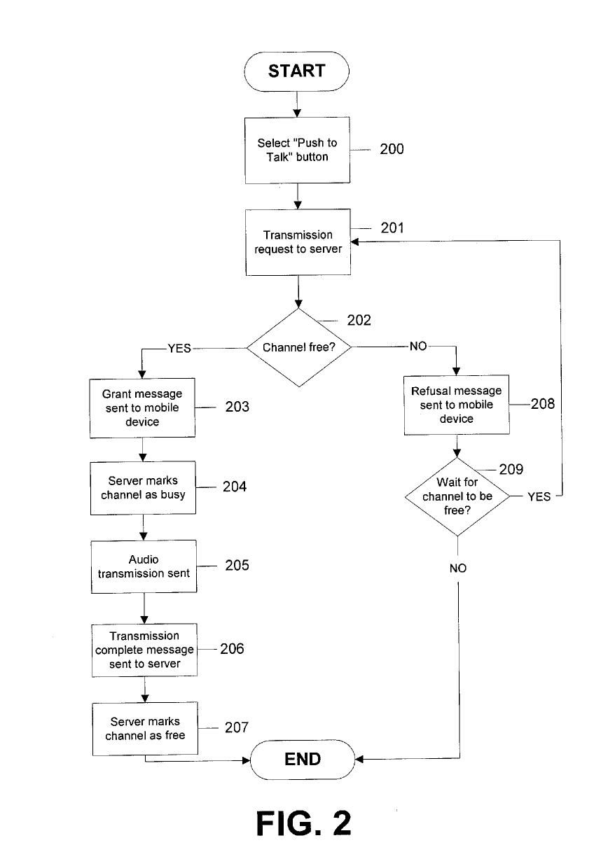

When the mobile device 20 engages the “Push to Talk” button, a transmission request 25 is sent to the server 30. In this case, since the mobile device 20 is second to send a request to the server 30, the mobile device 10 receives priority. Therefore, the server 30 transmits a refusal message 29 to the mobile device 20. The refusal message 29 indicates to the mobile device 20 that the indicated channel is not currently available. The refusal message 29 also inquires of the mobile device 20 if the mobile device 20 would like to wait for the channel to become available, as will be discussed with respect to FIG. 2 below.

FIG. 2 shows a first exemplary method for the first system of FIG. 1. The method of FIG. 2 will be described with reference to the system of FIG. 1. In step 200, the mobile device 10 may select the “Push to Talk” button. In step 201, a transmission request 15 may be sent to the server 30. The transmission request 15 may include information regarding the transmission including the channel being utilized, a timestamp indicating when the transmission was initiated, IP address of the mobile device 10, etc. When the server 30 receives this data from the mobile device 10, a check is performed to determine if the requested channel is free (step 202).

If it is determined that the channel is free in step 202, a grant message is sent to the mobile device 10 (step 203). In step 204, the server 30 marks the requested channel as busy so that no other mobile device may transmit any audio transmissions at the same time as the mobile device 10. In step 205, the mobile device 10 may send the audio transmission 11 to any plurality of recipients tuned into the channel in question. Once the audio transmission is complete and the mobile device 10 has released the “Push to Talk” button, a transmission complete message 16 may be sent to the server 30 to indicate that the requested channel is now free (step 206). Alternatively, the server 30 may monitor the channel to make this determination. The server 30 may then mark the channel as free in step 207 and the process may be ended.

If it is determined that the channel is not free in step 202, a refusal message is sent to the mobile device 10 in step 208. At this point, the mobile device 10 is prompted to request if the mobile device 10 would like to wait for the requested channel to be free (step 209). If the mobile device 10 decides to wait, it is placed in line and receives priority over the channel once the current transmission is complete. The process is looped back to step 201 and, as soon as the channel is free, a grant message is sent to the mobile device 10 and the method goes through steps 201-207 as mentioned above.

If, in step 209, the mobile device 10 decides not to wait for the requested channel to be free, the process is ended. If, at a later time, the mobile device 10 decides to again attempt to transmit an audio signal across this or any other channel, the mobile device 10 will now need to go through the entire method of FIG. 2 again.

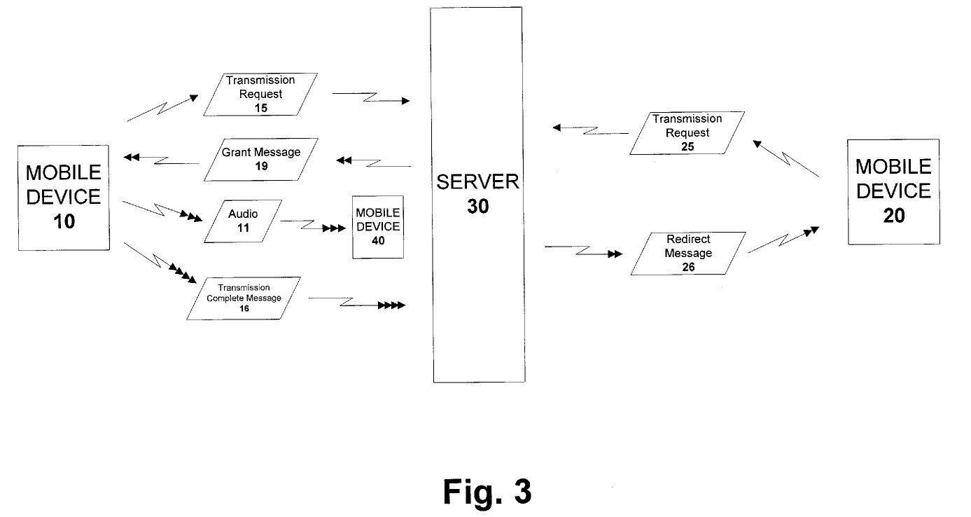

FIG. 3 shows a second exemplary system for employment of a channel access arbitration mechanism according to an exemplary embodiment of the present invention. This system employs the same overall structure as that of FIG. 1. However, in this system, when the mobile device 20 sends the transmission request 25 to the server 30 at a time when the channel is in use by the mobile device 10, the server 30 does not return a refusal message 29. Rather, the server 30 allows the mobile device 20 to be able to transmit the audio signal via a different channel. As such, once the server 30 receives the transmission request 25 from the mobile device 20, the server 30 checks to see if the requested channel is free. Once the server 30 determines that the requested channel is not free, it performs a scan to determine which channels are free. A redirect message 26 is then compiled and provides a list of alternatively available channels that may be utilized for the transmission The redirect message 26 is then sent to the mobile device 20 and indicates to the mobile device 20 that the requested channel is not free, providing a list of alternatively usable channels.

Those skilled in the art will understand that the list of alternatively available channels can be sought in several ways. For example, the server 30 may track activity across all channels within a given time frame and compile a list in order of least activity. As another means, the server 30 may track the channels recently used by the mobile device 20 and compile a list of available channels from within that scope. Those skilled in the art will understand that the number of channels provided in the redirect message 26 may range anywhere from one channel to any plurality of channels, as may be determined and adjusted by the user of the mobile device 20.

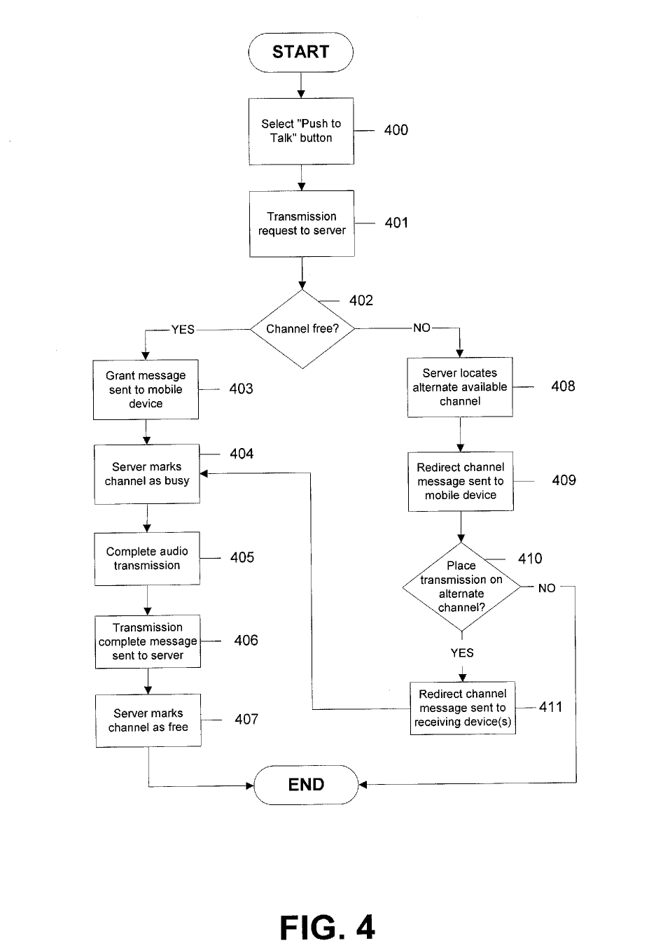

The redirect message 26 may be sent to other selected recipients as well, as shown in FIG. 4. This may allow any intended recipients of the mobile device 20's audio signal to all tune to the available channel. Upon receipt of the redirect message 26, the mobile device 20 may request that the redirect message 26 also be transmitted to a selected recipient(s). This request may be sent via a number of methods (e.g., the user interface of the mobile device 20 may display a prompt to request if forwarding should be done, the mobile device 20 may establish its settings to automatically forward the redirect message 26 to a certain predefined list of recipients, the mobile device 20 may manually forward the redirect message 26 to a list of recipients, etc.)

The redirect message 26 may enable the mobile device 20 to be able to transmit the audio transmission to the same recipients without having to wait for the requested channel to become available. Those skilled in the art will understand that, in addition to displaying a list of alternate channels, the redirect message may also automatically tune the receiving mobile device to an available channel. The user of said mobile device may selectively modify the above noted function (i.e., so that the device may be tuned to a new channel automatically, upon initiation by the user of said mobile device, etc.).

FIG. 4 shows a second exemplary method for the second system of FIG. 3. The method of FIG. 4 will be described with reference to the system of FIG. 3. In step 400, the mobile device 20 may select the “Push to Talk” button. In step 401, a transmission request 25 may be sent to the server 30. The transmission request 25 may include information regarding the transmission including the channel intended to be utilized, a timestamp indicating when the transmission was initiated, details regarding the mobile device 20, etc. When the server 30 receives this data from the mobile device 20, a check is performed to determine if the requested channel is free (step 402).

If it is determined that the channel is free in step 402, a grant message is sent to the mobile device 20 (step 403). In step 404, the server 30 marks the requested channel as busy so that no other mobile device may transmit any audio transmissions at the same time as the mobile device 20. In step 405, the mobile device 20 may send the audio transmission 11. Once the “Push to Talk” button is released, a transmission complete message 16 is then sent to the server 30 in step 406 and the server 30 consequently marks the requested channel as free in step 407 before the process is ended.

If it is determined that the channel is not free in step 402, the server 30 scans to determine which channels are available. Once the list of alternate available channel(s) has been compiled (step 408), the server 30 sends a redirect message 26 to the mobile device 20 (step 409). At this point, the mobile device 20 displays a prompt asking if the mobile device 20 would like to place the audio transmission on the alternate channel (step 410).

If the mobile device 20 decides not to place the audio transmission on the alternate channel, the process is ended. If the mobile device 20 does decide to place the audio transmission on the alternate channel, the process moves to step 411 where the redirect channel message is sent to the intended recipient(s) as described with respect to FIG. 3 above. The alternate channel is then marked as busy (step 404). The audio transmission 11 is then sent, the alternate channel marked as free, and the process ended (step 405-407).

Those skilled in the art will understand that the described exemplary embodiments of the present invention may be altered without departing from the spirit or scope of the invention. Thus, it is to be understood that these embodiments have been described in an exemplary manner and are not intended to limit the scope of the invention which is intended to cover all modifications and variations of this invention that come within the scope of the appended claims and their equivalents.

What is claimed is:

1. A method for arbitrating channel access, comprising:
sending by a device a request to access a channel;
checking if the requested channel is busy;
sending to the device an access grant message if the requested channel is available; and
sending to the device an access refusal message if the requested channel is busy.

2. The method according to claim 1, wherein the request to access a channel is sent by selecting a push-to-talk button.

3. The method according to claim 1, wherein the access grant message grants the device a right to the requested channel.

4. The method according to claim 1, wherein the access refusal message denies a right to the requested channel.

5. The method according to claim 3, further comprising:
forfeiting rights to a granted channel upon releasing a push-to-talk button.

6. The method according to claim 4, further comprising:
sending a transmission complete message to the server upon release of a push-to-talk button.

7. The method according to claim 1, wherein, if the channel is busy, further comprising:
checking if alternate channels are available; and
sending to the device a channel redirect message identifying at least one available alternate channel.

8. The method according to claim 7, further comprising:
automatically tuning to the at least one available alternate channel.

9. The method according to claim 7, further comprising:
selectively tuning to the at least one available alternate channel.

10. The method according to claim 7, further comprising:
sending the channel redirect message to a plurality of alternate recipients.

11. The method according to claim 10, wherein the alternate recipients are selected from a list determined by a user via the device.

12. The method according to claim 10, further comprising:
automatically tuning the alternate recipients to the at least one available alternate channel.

13. The method according to claim 10, further comprising:
selectively tuning the alternate recipients to the at least one available alternate channel.

14. A system for arbitrating channel access, comprising:
a telecommunications device sending a request to access a channel; and
a server including a processor programmed to:
send to the telecommunications device an access grant message if the requested channel is available, and
send to the telecommunications device an access refusal message if the requested channel is busy.

15. The system according to claim 14, wherein the processor is programmed to:
check, if the channel is busy, if alternate channels are available; and
send, if the channel is busy, a channel redirect message to the device identifying at least one available alternate channel.

16. The system according to claim 15, wherein the telecommunications device is capable of:
forfeiting rights to a granted channel.

17. The system according to claim 15, wherein the telecommunications device is capable of:
sending a transmission complete message to the server.

18. The system according to claim 15, wherein the telecommunications device is capable of:
automatically tuning to the at least one available alternate channel.

19. The system according to claim 15, wherein the telecommunications device is capable of:
selectively tuning to the at least one available alternate channel.

20. The system according to claim 15, wherein the processor is programmed for:
send the channel redirect message to a plurality of alternate recipients.

21. A system for arbitrating channel access, comprising:
means for sending by a device a request to access a channel;
means for checking if the requested channel is busy;
means for sending to the device an access grant message if the requested channel is available; and
means for sending to the device an access refusal message if the requested channel is busy.
